(19) United States
(12) Patent Application Publication
(10) Pub. No.: US 2024/0251708 A1
(43) Pub. Date: Aug. 1, 2024

(54) LAWN MOWER

(71) Applicant: HONDA MOTOR CO., LTD., Tokyo (JP)

(72) Inventors: Fumio Minami, Wako-shi (JP); Tatsuya Yamazaki, Wako-shi (JP); Taichi Kubota, Wako-shi (JP); Yuko Nishi, Wako-shi (JP); Shin Murakami, Wako-shi (JP)

(21) Appl. No.: 18/160,592

(22) Filed: Jan. 27, 2023

(51) Int. Cl. A01D 34/81; A01D 34/68; A01D 34/73

(52) U.S. Cl. CPC A01D 34/81; A01D 34/68; A01D 34/733; A01D 2101/00

(57) ABSTRACT

The lawn mower includes a cutter blade and a rotary shaft for rotating the cutter blade, and cuts grass by rotating the cutter blade while traveling. In a state where the lawn mower is horizontally disposed, the rotary shaft is held so as to be inclined forward in a traveling direction of the lawn mower, with respect to the direction of gravity.

### BACKGROUND OF THE INVENTION

### Field of the Invention

The present invention relates to a lawn mower.

### Description of the Related Art

In recent years, research and development have been conducted to contribute to energy efficiency in order to ensure access to affordable, reliable, sustainable and advanced energy for more people. WO 2021/110414 A1 discloses a lawn mower that cuts grass by rotating a cutter blade while traveling.

### SUMMARY OF THE INVENTION

There is a need for lawn mowers that can more efficiently shred lawn grass.

An object of the present invention is to meet the above-mentioned need.

According to an aspect of the present invention, there is provided a lawn mower including: a cutter blade; a rotary shaft configured to rotate the cutter blade; the lawn mower being configured to cut grass by rotating the cutter blade while traveling, wherein, in a state where the lawn mower is horizontally disposed, the rotary shaft is held so as to be inclined forward in a traveling direction of the lawn mower, with respect to a direction of gravity.

According to the present invention, it is possible to efficiently shred lawn grass.

The above objects, features, and advantages will be easily understood from the following description of embodiments when taken in conjunction with the accompanying drawings.

### BRIEF DESCRIPTION OF THE DRAWINGS

FIG. 1 is a side view of a lawn mower;

FIG. 2 is a perspective view of a cutter blade of the lawn mower of FIG. 1;

FIG. 3 is a plan view of the cutter blade;

FIG. 4 is a front view of the cutter blade;

FIG. 5 is a plan view of the lower blade member;

FIG. 6 is a side view of the lower blade member; and

FIG. 7 is an explanatory view of a cutting region of the cutter blade.

### DETAILED DESCRIPTION OF THE INVENTION

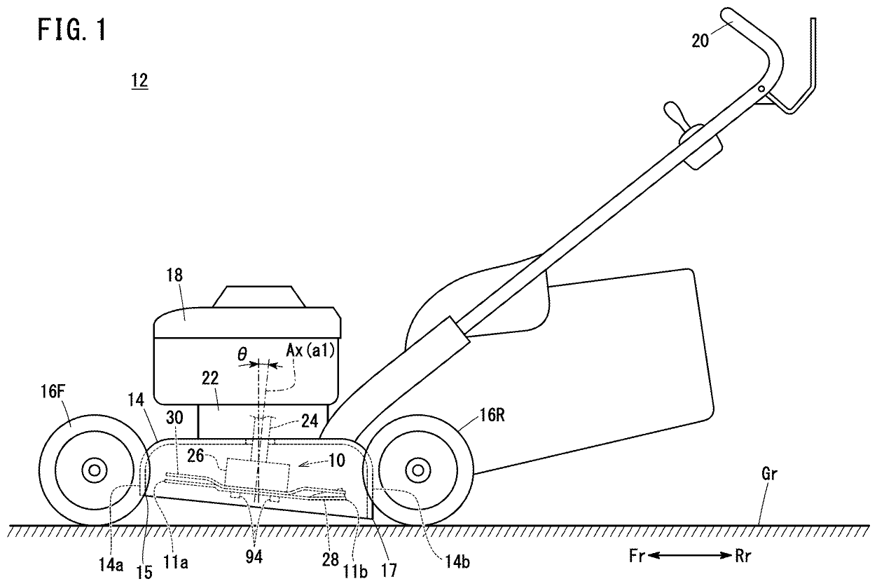

A lawn mower 12 according to an embodiment of the present invention will be described below with reference to the drawings. As shown in FIG. 1, the lawn mower 12 is a walk-behind, self-propelled working machine that cuts lawn grass with a rotating cutter blade 10 (rotary blade). The lawn mower is not limited to a walk-behind, self-propelled working machine, and may be a robot type working machine. In FIG. 1, the direction of arrow Fr indicates the front side of the lawn mower 12 (the forward in the direction of travel), and the direction of arrow Rr indicates the rear side of the lawn mower 12 (the rearward in the direction of travel).

The lawn mower 12 includes a housing 14, left and right front wheels 16F, left and right rear wheels 16R, the cutter blade 10, a prime mover 18, and an operation handle 20. The left and right front wheels 16F are disposed on both sides of a front portion of the housing 14. The left and right rear wheels 16R are disposed on both sides of a rear portion of the housing 14. The left and right rear wheels 16R are drive wheels rotated by the driving force of the prime mover 18. The driving force of the prime mover 18 is not transmitted to the left and right front wheels 16F. The cutter blade 10 is housed in the housing 14. The prime mover 18 is disposed on an upper side of the housing 14. The operation handle 20 extends rearward and obliquely upward from the housing 14.

The lawn mower 12 rotates the cutter blade 10 by the prime mover 18 to thereby cut (mow) lawn grass that is under the lawn mower 12 and further shred the cut lawn grass, which is fragments of the cut grass, with the cutter blade 10. The rotation direction of the cutter blade 10 is a clockwise direction when viewed from above, but is not limited thereto. The shredded grass clippings fall on the ground Gr by gravity and are decomposed into fertilizer. Such a mowing technique is called mulching. The lawn mower 12 may include a lawn storage (not shown) for storing grass clippings.

The housing 14 is a casing in which only a portion facing the ground Gr (lawn) is opened downward. A prime mover base 22 is attached to an upper surface of the housing 14. The prime mover 18 is attached to an upper surface of the prime mover base 22. The lawn mower 12 is equipped with an electric motor as the prime mover 18. The electric motor is driven by electric power supplied from a battery (not shown). In this case, the battery may be attachable to and detachable from the prime mover base 22. Note that the prime mover 18 is not limited to such an electric motor, and may be an engine, for example. The prime mover 18 has a rotary shaft 24 projecting downward and extending into the housing 14.

In a state where the lawn mower 12 is disposed horizontally (i.e., the state of the lawn mower 12 shown in FIG. 1), the rotary shaft 24 is held so as to be inclined forward in the direction of travel (the traveling direction) (arrow Fr), with respect to the direction of gravity. In other words, the prime mover 18 is fixed to the prime mover base 22 such that the rotary shaft 24 is inclined forward in the direction of travel, with respect to the direction of gravity. That is, the rotary shaft 24 does not move in a tilting manner with respect to the prime mover base 22 and the housing 14. The inclination angle θ of the rotation axis Ax of the rotary shaft 24 with respect to the vertical direction is preferably set to, for example, 0.5° or more and 10° or less. The inclination angle θ is more preferably set to 0.5° or more and 5° or less. More preferably, the inclination angle θ is set to about 1°. The inclination angle θ does not change during grass mowing.

The housing 14 houses therein the cutter blade 10. The housing 14 includes a front wall 14a and a rear wall 14b. The front wall 14a is positioned on the front side of the rotary shaft 24 in the traveling direction (i.e., the direction of arrow Fr). The rear wall 14b is located on the rear side of the rotary shaft 24 in the traveling direction (i.e., the direction of arrow Rr). In a state where the lawn mower 12 is disposed horizontally, the position of a lower end 15 of the front wall 14a in the vertical direction is higher than the position of a lower end 17 of the rear wall 14b in the vertical direction. As a result, it is possible to prevent the lawn grass positioned in front of the rotary shaft 24 in the traveling direction from being caused to fall down by the front wall 14a before being cut by the cutter blade 10.

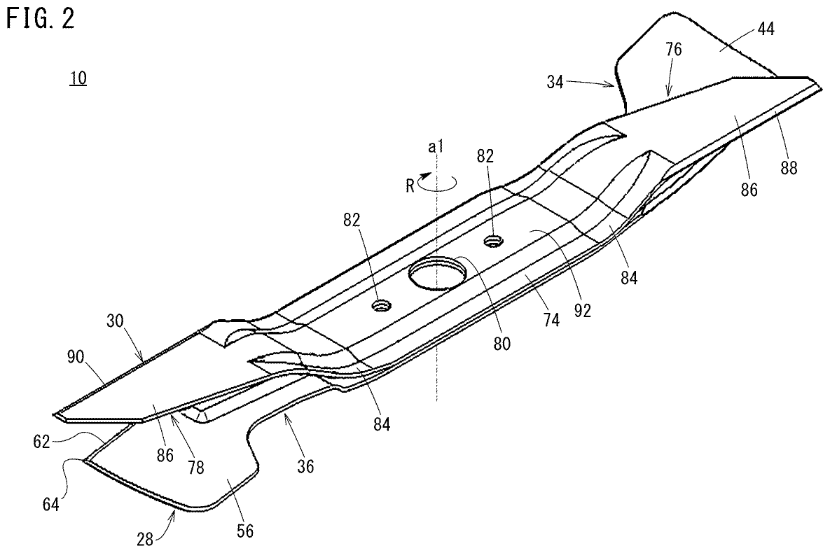

The cutter blade 10 is coupled to the rotary shaft 24 of the prime mover 18, and is rotated by a rotational driving force transmitted from the rotary shaft 24. Hereinafter, the rotation direction of the cutter blade 10 (the direction of arrow R in FIG. 2) is also referred to as a “blade rotation direction”. The direction opposite to the blade rotation direction may be referred to as the “reverse rotation direction”.

The cutter blade 10 is attached to the rotary shaft 24 via a blade holder 26. The blade holder 26 is attached to a central portion of the cutter blade 10. The blade holder 26 is coupled to a lower end portion of the rotary shaft 24 coaxially with the rotary shaft 24. Therefore, in the lawn mower 12, the rotation center line al (see FIG. 2) of the cutter blade 10 coincides with the rotation axis Ax of the rotary shaft 24. The rotation center line al of the cutter blade 10 is not necessarily required to coincide with the rotation axis Ax of the rotary shaft 24. For example, the rotation center line al of the cutter blade 10 may be arranged at a position offset in a direction perpendicular to the rotation axis Ax of the rotary shaft 24 and extend in parallel to the rotation axis Ax.

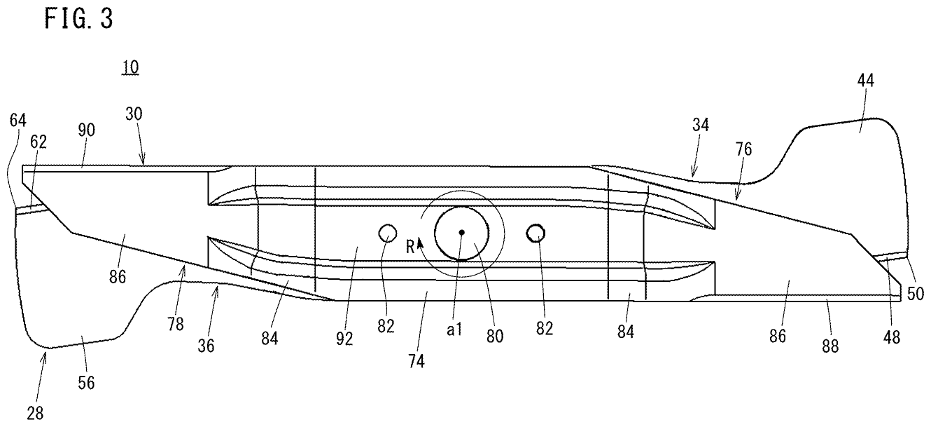

As shown in FIGS. 2 and 3, the cutter blade 10 includes a lower blade member 28 and an upper blade member 30, which are disposed so as to overlap each other in the thickness direction. Each of the lower blade member 28 and the upper blade member 30 is a plate-shaped elongated member (bar blade) extending in a direction orthogonal to the rotation center line al (i.e., to the rotary shaft 24 in FIG. 1).

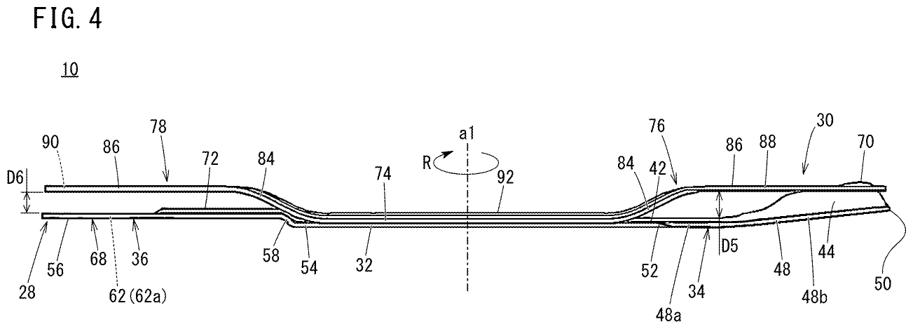

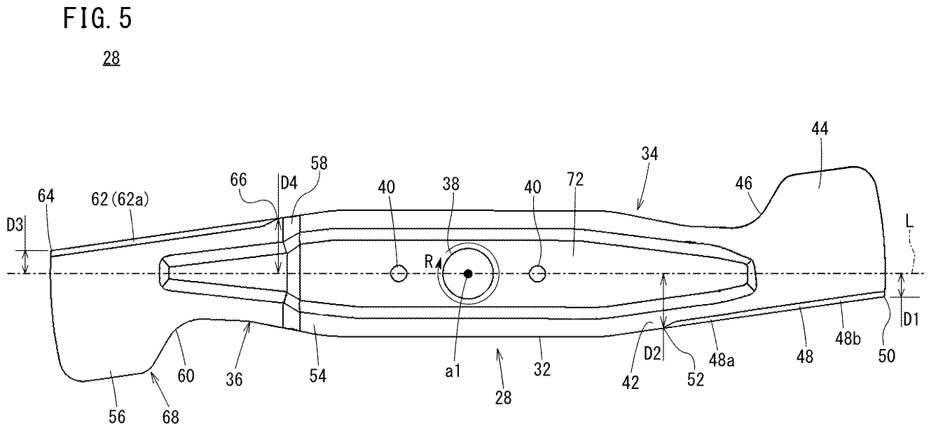

The lower blade member 28 (see FIGS. 4 and 5) is manufactured by, for example, plastically deforming, by press working, a single metal thin plate having a point-symmetric shape. The lower blade member 28 is made of a metal material such as steel, for example. The constituent material of the lower blade member 28 is not limited to a metal material and may be a resin material or the like.

As shown in FIGS. 4 and 5, the lower blade member 28 includes a lower attachment portion 32 (attachment portion), a first arm portion 34, and a second arm portion 36. The lower attachment portion 32 extends in the direction perpendicular to the rotation center line al of the cutter blade 10 (see FIG. 4). The lower attachment portion 32 is located at a longitudinal center of the lower blade member 28.

As shown in FIG. 5, the lower attachment portion 32 includes a lower insertion hole 38 and a pair of lower attachment holes 40. The lower insertion hole 38 is located at the center of the lower attachment portion 32. The pair of lower attachment holes 40 are positioned so as to sandwich therebetween the lower insertion hole 38 in the longitudinal direction of the lower blade member 28.

The first arm portion 34 and the second arm portion 36 each extend from the lower attachment portion 32 in a radially outward direction thereof. Specifically, the first arm portion 34 and the second arm portion 36 extend in mutually opposite directions with the lower attachment portion 32 being centered. The total weight of the first arm portion 34 is the same as the total weight of the second arm portion 36. The outer dimensions of the first arm portion 34 in a plan view are approximately equal to the outer dimensions of the second arm portion 36 in a plan view.

The first arm portion 34 includes a first arm body 42 (first blade body) and a wing portion 44. The first arm body 42 extends from the lower attachment portion 32 in the radially outward direction. The first arm body 42 extends in a direction orthogonal to the rotation center line al of the cutter blade 10 (see FIG. 4). In FIG. 5, the first arm body 42 is formed to be narrower toward the outer side in the radial direction. The width of the first arm body 42 is a dimension along the blade rotation direction.

The wing portion 44 generates an ascending air current when the lower blade member 28 rotates. The wing portion 44 is connected to an extending end portion of the first arm body 42. The wing portion 44 is formed on a portion including a radially outer end portion (an end portion in the radially outward direction) of the first arm portion 34. The wing portion 44 is formed into a quadrangular shape in plan view. The wing portion 44 protrudes in the reverse rotation direction from a radially outer end 46 of an edge portion (rear edge portion), of the first arm body 42, that faces in the reverse rotation direction.

As shown in FIG. 4, in a horizontal placement state in which the cutter blade 10 is placed such that the rotation center line al of the cutter blade 10 is oriented in the vertical direction, the wing portion 44 is inclined upward toward the radially outward direction. That is, in the state where the cutter blade 10 is horizontally disposed, the first arm portion 34 is inclined upward toward the radially outward direction.

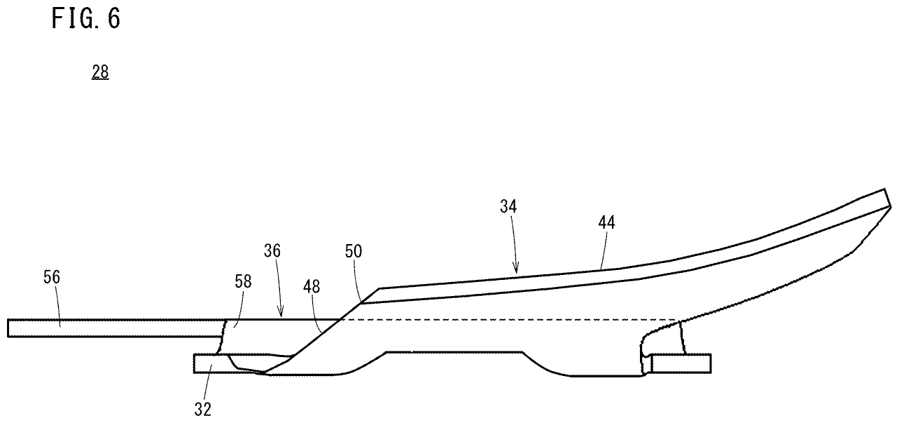

As shown in FIG. 6, in the state where the cutter blade 10 is horizontally disposed, the wing portion 44 is inclined upward, with respect to the reverse rotation direction over the entire width of the wing portion 44. In other words, in the state where the cutter blade 10 is horizontally placed, the wing portion 44 protrudes upward in the reverse rotation direction. The upper surface of the wing portion 44 is curved in an arc shape.

As shown in FIG. 5, a first blade portion 48 capable of cutting grass is formed at an edge portion (front edge portion), of the first arm portion 34, that faces in the blade rotation direction. The first blade portion 48 includes a first base blade 48a and an inclined blade 48b. The first base blade 48a extends in the direction orthogonal to the rotation center line al of the cutter blade 10 (see FIG. 4). The first base blade 48a is formed at a front edge portion of the first arm body 42. In the horizontal placement state of the cutter blade 10, the inclined blade 48b is inclined upward, in a direction from the radially outer end of the first base blade 48a toward the radially outer side (see FIG. 4).

A radially outer end 50 of the first blade portion 48 is offset in the reverse rotation direction from a radially inner end 52 of the first blade portion 48. In other words, the shortest distance D1 between the radially outer end 50 of the first blade portion 48 and a line segment L is shorter than the shortest distance D2 between the radially inner end 52 of the first blade portion 48 and the line segment L. The line segment L is a line segment that extends in the longitudinal direction of the lower blade member 28 and passes through the rotation center line al of the cutter blade 10. In the horizontal placement state of the cutter blade 10, the position of the radially outer end 50 of the first blade portion 48 in the vertical direction is higher than the position of the radially inner end 52 of the first blade portion 48 in the vertical direction (see FIG. 4).

The second arm portion 36 includes a second arm body 54 (second blade body) and a balance portion 56 connected to an extending end portion of the second arm body 54. The second arm portion 36 is not provided with a wing portion. The second arm body 54 extends from the lower attachment portion 32 in a direction opposite to the direction in which the first arm body 42 extends. The second arm body 54 is formed so as to become narrower toward the radially outer side. The width of the second arm body 54 is a dimension along the blade rotation direction.

As shown in FIG. 4, the second arm body 54 is formed with an upward extending portion 58 extending upward in the radially outward direction. The upward extending portion 58 is a stepped portion that is bent upward toward the radially outer side of the second arm body 54. In FIG. 5, the upward extending portion 58 extends linearly over the entire width of the second arm body 54. The upward extending portion 58 is positioned at an intermediate portion of the second arm body 54 in the extending direction. A portion of the second arm body 54 lying radially inward of the upward extending portion 58 and a portion of the second arm body 54 lying radially outward of the upward extending portion 58 extend in the direction orthogonal to the rotation center line al of the cutter blade 10 (see FIG. 4).

The upward extending portion 58 may be an inclined portion that is inclined upward toward the radially outer side of the second arm body 54. The inclined portion may extend from the intermediate portion of the second arm body 54 in the extending direction to the radially outer end of the second arm portion 36 (the radially outer end of the balance portion 56). Alternatively, the inclined portion may extend from the intermediate portion of the second arm body 54 in the extending direction to an intermediate portion of the balance portion 56 in the extending direction of the second arm portion 36. Further, the inclined portion may be provided only in the second arm body 54 and may not be provided in the balance portion 56.

The balance portion 56 is formed in a portion including a radially outer end portion of the second arm portion 36. The balance portion 56 is formed into a quadrangular shape in plan view. The balance portion 56 protrudes in the reverse rotation direction from a radially outer end 60 of a rear edge portion of the second arm body 54. The balance portion 56 extends in the direction orthogonal to the rotation center line al of the cutter blade 10. That is, in the horizontal placement state of the cutter blade 10, the balance portion 56 extends along the horizontal direction. Therefore, the balance portion 56 does not function as a wing portion that generates an ascending air current.

A second blade portion 62 capable of cutting grass is formed at a front edge portion of the second arm portion 36. The second blade portion 62 is a second base blade 62a extending in the direction orthogonal to the rotation center line al of the cutter blade 10. The second blade portion 62 extends from the second arm body 54 to a radially outer end of the balance portion 56. A radially outer end 64 of the second blade portion 62 is offset from a radially inner end 66 of the second blade portion 62 in the reverse rotation direction. In other words, the shortest distance D3 between the radially outer end 64 of the second blade portion 62 and the line segment L is shorter than the shortest distance D4 between the radially inner end 66 of the second blade portion 62 and the line segment L.

The radially inner end 66 of the second blade portion 62 is positioned radially outward of the upward extending portion 58. As shown in FIG. 4, in the horizontal placement state of the cutter blade 10, the position of the first base blade 48a in the vertical direction is lower than the position of the second blade portion 62 (the second base blade 62a) in the vertical direction. In the horizontal placement state of the cutter blade 10, the position of the second blade portion 62 (the second base blade 62a) in the vertical direction is lower than the position of the radially outer end 50 of the first blade portion 48 in the vertical direction. When the upward extending portion 58 is an inclined portion, the radially inner end 66 of the second blade portion 62 may be positioned radially outward of the inclined portion, or may be located at an intermediate position on the inclined portion.

That is, in the horizontal placement state of the cutter blade 10, the position of a first portion of the first blade portion 48 in the vertical direction and the position of a second portion of the second blade portion 62 in the vertical direction are different from each other. The distance from the rotation center line al to the first portion and the distance from the rotation center line al to the second portion are equal to each other. In other words, the trajectory along which the first portion passes during rotation of the cutter blade 10 and the trajectory along which the second portion passes during rotation of the cutter blade 10 coincide with each other in plan view.

An outer portion 68 of the second arm portion 36, which extends radially outward beyond the upward extending portion 58, extends in the direction perpendicular to the rotation center line al of the cutter blade 10. In the horizontal placement state of the cutter blade 10, the position of the outer portion 68 of the second arm portion 36 in the vertical direction is lower than the position of an uppermost end 70 of the wing portion 44.

As shown in FIG. 5, the lower blade member 28 includes a first projection 72 for reinforcement, formed thereon. The first projection 72 extends from the radially outer end of the first arm body 42 to the radially outer end of the second arm body 54. The position, size, and shape of the first projection 72 can be set as appropriate. The first projection 72 may not be formed on the lower blade member 28.

As shown in FIGS. 2 to 4, the upper blade member 30 is manufactured by, for example, plastically deforming a single metal thin plate having a point-symmetric shape, by press working. The upper blade member 30 is made of a metal material such as steel, for example. The constituent material of the upper blade member 30 is not limited to a metal material and may be a resin material or the like.

In FIG. 3, the upper blade member 30 is formed point-symmetrically about the rotation center line al of the cutter blade 10. The upper blade member 30 includes an upper attachment portion 74, a third arm portion 76, and a fourth arm portion 78. The upper attachment portion 74 extends in a direction orthogonal to the rotation center line al of the cutter blade 10. The upper attachment portion 74 is located at a central portion of the upper blade member 30 in the longitudinal direction.

An upper insertion hole 80 and a pair of upper attachment holes 82 are formed in the upper attachment portion 74. The upper insertion hole 80 is located at the center of the upper attachment portion 74. The pair of upper attachment holes 82 are positioned so as to sandwich the upper insertion hole 80 in the longitudinal direction of the upper blade member 30. The upper attachment portion 74 has such a size and shape that the upper attachment portion can be superimposed on the lower attachment portion 32 in close contact with each other.

The third arm portion 76 and the fourth arm portion 78 each extend from the upper attachment portion 74 in the radially outward direction. Specifically, the third arm portion 76 and the fourth arm portion 78 extend in mutually opposite directions with the upper attachment portion 74 being centered.

As shown in FIGS. 2 to 4, the third arm portion 76 includes a rising portion 84 and an outward extending portion 86. In the horizontal placement state of the cutter blade 10, the rising portion 84 is inclined obliquely upward from the upper attachment portion 74 toward the radially outer side. The outward extending portion 86 extends in the direction orthogonal to the rotation center line al of the cutter blade 10. That is, in the horizontal placement state of the cutter blade 10, the outward extending portion 86 horizontally extends from the rising portion 84 in the radially outward direction. The outward extending portion 86 is formed so as to become narrower toward the radially outer side (see FIG. 3).

A third blade portion 88 capable of cutting grass is formed at a front edge portion of the outward extending portion 86 of the third arm portion 76. The third blade portion 88 extends linearly over substantially the entire length of the outward extending portion 86 of the third arm portion 76. The third blade portion 88 extends along the longitudinal direction of the upper blade member 30.

The fourth arm portion 78 is formed in the same manner as the third arm portion 76. Therefore, a detailed description of the fourth arm portion 78 will be omitted. A fourth blade portion 90 capable of cutting grass is formed at a front edge portion of the outward extending portion 86 of the fourth arm portion 78. The fourth blade portion 90 is configured similarly to the third blade portion 88.

As shown in FIGS. 2 and 3, the upper blade member 30 is formed with a second projection 92 for reinforcement. The second projection 92 extends from the radially outer end of the rising portion 84 of the third arm portion 76 to the radially outer end of the rising portion 84 of the fourth arm portion 78. The position, size, and shape of the second projection 92 can be set as appropriate. The upper blade member 30 may not be provided with the second projection 92.

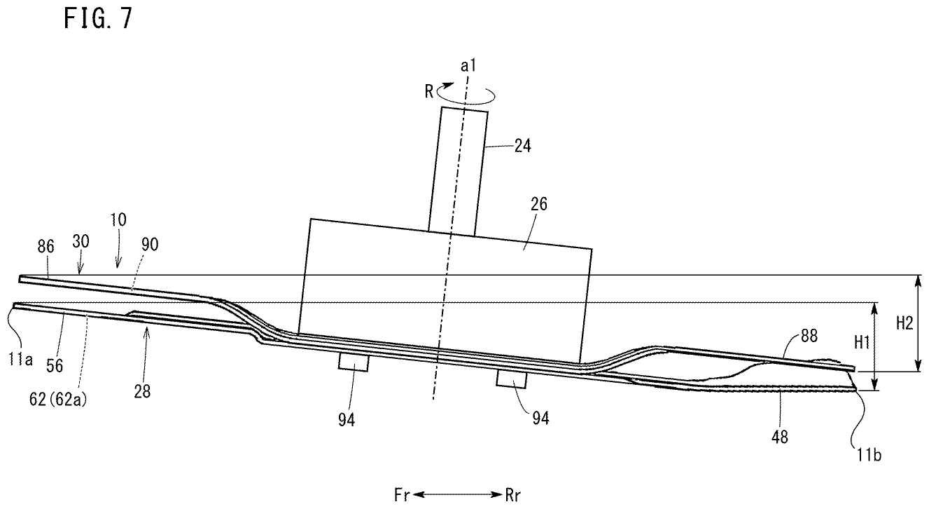

As shown in FIG. 7, the lower blade member 28 and the upper blade member 30 are attached to the blade holder 26 by a pair of bolts 94 in a state where the lower blade member 28 and the upper blade member 30 are overlapped with each other (overlapping state). Specifically, as shown in FIGS. 2 and 7, in the overlapping state, the first projection 72 enters the inside of the second projection 92, and the lower surface of the upper attachment portion 74 comes into close contact with the upper surface of the lower attachment portion 32. In the overlapped state, the lower insertion hole 38 and the lower attachment holes 40 communicate with the upper insertion hole 80 and the upper attachment holes 82, respectively (see FIG. 2). The lower end portion of the rotary shaft 24 is inserted into the lower insertion hole 38 and the upper insertion hole 80. The bolts 94 are inserted through the lower attachment holes 40 and the upper attachment holes 82.

As shown in FIG. 3, at least a portion of the outward extending portion 86 of the third arm portion 76 overlaps the first arm portion 34 in plan view, and at least a portion of the outward extending portion 86 of the fourth arm portion 78 overlaps the second arm portion 36 in plan view. The position of the third blade portion 88 is shifted from the position of the first blade portion 48 in the blade rotation direction. The position of the fourth blade portion 90 is shifted from the position of the second blade portion 62 in the blade rotation direction.

As shown in FIG. 4, the outward extending portion 86 of the third arm portion 76 is spaced upward from the first arm portion 34. The outward extending portion 86 of the fourth arm portion 78 is spaced upward from the second arm portion 36. In the horizontal placement state of the cutter blade 10, the position of the uppermost end 70 of the wing portion 44 is higher than the position, in the vertical direction, of the upper surface of the outward extending portion 86 of the third arm portion 76.

In the horizontal placement state of the cutter blade 10, the position in the vertical direction of the lower surface of the radially outer end portion of the third arm portion 76 is higher than the position in the vertical direction of the upper surface of the first arm body 42 by a first distance D5. Further, in the horizontal placement state of the cutter blade 10, the vertical position of the lower surface of the radially outer end portion of the fourth arm portion 78 is higher than the vertical position of the upper surface of the radially outer end portion (balance portion 56) of the second arm portion 36 by a second distance D6. The first distance D5 is greater than the second distance D6.

As shown in FIGS. 1 and 7, in a state where the cutter blade 10 is attached to the blade holder 26 (i.e., a state where the lawn mower 12 is disposed horizontally), the rotation center line al is inclined forward in the traveling direction, with respect to the direction of gravity. In this case, as shown in FIG. 7, during one rotation of the cutter blade 10, the first blade portion 48 and the second blade portion 62 of the lower blade member 28 pass through a first height region H1. As a result, grass (including grass clippings) located within the first height region H1 can be cut by the lower blade member 28.

During one rotation of the cutter blade 10, the third blade portion 88 and the fourth blade portion 90 of the upper blade member 30 pass through a second height region H2. Thus, grass (including grass clippings) located within the second height region H2 can be cut by the upper blade member 30. The size of each of the first height region H1 and the second height region H2 can be appropriately set.

As shown in FIGS. 1 and 7, in a state where the lawn mower 12 is horizontally disposed, when the cutter blade 10 is at such a rotational position that the cutter blade extends in the front-rear direction of the lawn mower 12, the vertical position of the lowermost end 11a of the front end portion of the cutter blade 10 is higher than the vertical position of the lowermost end 11b of the rear end portion of the cutter blade 10. Thus, the cutting position, in the height direction, of the cutter blade 10 on the rear side of the rotary shaft 24 is lower than the cutting position, in the height direction, of the cutter blade 10 on the front side of the rotary shaft 24. That is, the lawn grass (lawn grass growing on the ground Gr) cut short by the cutter blade 10 in front of the rotary shaft 24 can be cut further shorter by the cutter blade 10 behind the rotary shaft 24. In other words, the cutter blade 10 can cut grass at different heights in front of and behind the rotary shaft 24.

As shown in FIG. 1, the lowermost end 11b of the cutter blade 10 is located below the lower end 15 of the front wall 14a of the housing 14. The cutter blade 10 cuts grass rearward of the left and right front wheels 16F. In other words, the cutter blade 10 can cut the grass trodden by the left and right front wheels 16F. The length of the cutter blade 10 in the longitudinal direction is longer than the distance between the left and right front wheels 16F.

Next, the operation of the lawn mower 12 will be described.

When the cutter blade 10 rotates during traveling of the lawn mower 12, lawn grass grown on the ground Gr directly below the lawn mower 12 is cut by the cutter blade 10. Specifically, the grass is cut by the cutter blade 10 in front of the rotary shaft 24. Thereafter, the lawn mower 12 moves forward, so that the lawn grass cut short by the cutter blade 10 (lawn grass growing on the ground Gr) is positioned rearward of the rotary shaft 24. Therefore, the grass is cut again rearward of the rotary shaft 24 by the cutter blade 10, at a lower position. In such a case, the grass cut by the cutter blade 10 in front of the rotary shaft 24 in the traveling direction falls down (inclines) along the blade rotation direction (the direction of arrow R) of the cutter blade 10. On the other hand, at the rear of the rotary shaft 24 in the traveling direction, the cutter blade 10 comes into contact with and hits the lawn grass from a direction opposite to the direction in which the lawn grass has fallen down. Therefore, at the rear of the rotary shaft 24 in the traveling direction, the cutter blade 10 can efficiently cut the fallen grass while raising the fallen grass.

During the rotation of the cutter blade 10, the cutter blade 10 generates an ascending air current by the action of the wing portion 44. Therefore, the grass growing on the ground Gr can be raised by the ascending air current and efficiently cut by the cutter blade 10.

The grass (grass clippings) cut by the cutter blade 10 is convected in the housing 14 by the action of the ascending air current. The cut grass which is convecting is shredded by the cutter blade 10. The shredded grass clippings fall on the ground Gr to serve as a fertilizer for the lawn. In this case, since the shredded grass clippings are less likely to accumulate on the lawn, the appearance of the lawn is improved.

The upper blade member 30 may be omitted from the cutter blade 10. Although a configuration in which the lower blade member 28 includes two arm portions (the first arm portion 34 and the second arm portion 36) has been described in the present embodiment, the number of arm portions included in the lower blade member 28 may be three or more. In this case, the plurality of arm portions are preferably arranged at equal intervals in the blade rotation direction. This arrangement can prevent vibration of the cutter blade 10 during rotation.

In the present embodiment, the case where the wing portion 44 is provided only on the first arm portion 34 has been described as an example, but the present invention is not limited thereto. The wing portion 44 may be provided on each of the first arm portion 34 and the second arm portion 36. The cutter blade 10 may have a structure in which a cutting piece is attached to a circular disk.

### Invention Obtained from Embodiment

The invention that can be grasped from the above embodiment will be described below.

An aspect of the present invention is characterized by the lawn mower (12) including: the cutter blade (10); the rotary shaft (24) configured to rotate the cutter blade, the lawn mower being configured to cut grass by rotating the cutter blade while traveling, wherein, in the state where the lawn mower is horizontally disposed, the rotary shaft is held so as to be inclined forward in the traveling direction of the lawn mower, with respect to the direction of gravity.

With such a configuration, the cutting position of the cutter blade on the rear side of the rotary shaft can be made lower than the cutting position of the cutter blade on the front side of the rotary shaft. As a result, the lawn grass can be cut in stages when the lawn mower travels. Therefore, lawn grass can be efficiently shredded. In addition, even when the lawn mower performs a wheelie at the time of acceleration or the like, the height position of the cutter blade is less likely to be shifted upward at the rear side of the rotary shaft, and thus it is possible to suppress a change in the mowing height of the lawn grass. Further, since the rotary shaft is inclined forward in the traveling direction, with respect to the gravity direction, the position of the center of gravity of the lawn mower in the front-rear direction can be shifted rearward in the traveling direction as compared with a case where the rotation shaft is not inclined. As a result, the tread pressure of the left and right front wheels can be reduced, so that the lawn grass trodden by the left and right front wheels can be made less likely to fall down. Therefore, the grass can be easily cut, by the cutter blade, in a position rearward of the left and right front wheels.

In the above-described lawn mower, the cutter blade may include the lower blade member (28) and the upper blade member (30) which are disposed so as to overlap each other in the thickness direction thereof.

With such a configuration, the lawn grass can be shredded more efficiently by the lower blade member and the upper blade member.

In the lawn mower, the cutter blade may include: the attachment portion (32) attached to the rotary shaft; and the first arm portion (34) and the second arm portion (36) each extending from the attachment portion in the radially outward direction of the rotary shaft. The first arm portion may include the first blade portion (48) configured to cut the grass. The second arm portion may include the second blade portion (62) configured to cut the grass. In the horizontal placement state in which the cutter blade is placed in a manner so that the rotation center line (al) of the cutter blade extends along the vertical direction, the position of the first portion of the first blade portion in the vertical direction and the position of the second portion of the second blade portion in the vertical direction may be different from each other. The distance from the rotation center line to the first portion and the distance from the rotation center line to the second portion may be equal to each other.

With such a configuration, the first portion and the second portion, which are at the same distance from the rotation center line of the cutter blade, can be made different, from each other, in height position at which grass (including grass clippings) is cut, and thus the grass can be efficiently shredded.

The above lawn mower may further include the housing (14) configured to house the cutter blade therein. The housing may include: the front wall (14a) located forward of the rotary shaft in the traveling direction; and the rear wall (14b) located rearward of the rotary shaft in the traveling direction. In a state where the lawn mower is disposed horizontally, the position of the lower end (15) of the front wall in the vertical direction may be higher than the position of the lower end (17) of the rear wall in the vertical direction.

With such a configuration, since it is possible to prevent falling down of the grass from being caused by the front wall, the grass can be more efficiently cut by the cutter blade.

In the above-described lawn mower, the first arm portion and the second arm portion may extend in directions opposite to each other with the attachment portion being centered.

With such a configuration, couple unbalance of the cutter blade can be suppressed, and thus vibration of the cutter blade during rotation can be suppressed.

The above lawn mower may further include: the attachment portion attached to the rotary shaft; and the first arm portion and the second arm portion each extending from the attachment portion in the radially outward direction. Only the first arm portion among the first arm portion and the second arm portion may include the wing portion (44) that is inclined upward, with respect to the reverse rotation direction opposite to the blade rotation direction which is the rotation direction of the cutter blade.

With such a configuration, when the cutter blade is rotated, an ascending air current can be generated by the wing portion of the first arm portion. As a result, the grass can be raised by the action of the ascending air current, so that the grass can be cut efficiently. Further, since grass clippings, which are cut grass, can be convected by the action of the ascending air current, the grass clippings can be shredded. Further, since the wing portion is provided only on the first arm portion among the first arm portion and the second arm portion, air resistance received by the cutter blade can be reduced as compared with a case where the wing portions are provided on both the first arm portion and the second arm portion. Therefore, energy consumption (power consumption) during rotation of the cutter blade can be suppressed. In addition, although noise is generated due to pressure fluctuation caused by the wing portion, causes of the pressure fluctuation are reduced as compared with a case where the wing portion is provided on each of the first arm portion and the second arm portion, and thus it is possible to suppress noise during rotation of the cutter blade.

Note that the present invention is not limited to the above-described disclosure, and various configurations can be adopted without departing from the essence and gist of the present invention.

1. A lawn mower comprising:
a cutter blade;
a rotary shaft configured to rotate the cutter blade;
the lawn mower being configured to cut grass by rotating the cutter blade while traveling,
wherein, in a state where the lawn mower is horizontally disposed, the rotary shaft is held so as to be inclined forward in a traveling direction of the lawn mower, with respect to a direction of gravity.

2. The lawn mower according to claim 1, wherein
the cutter blade includes a lower blade member and an upper blade member which are disposed so as to overlap each other in a thickness direction thereof.

3. The lawn mower according to claim 1, wherein:
the cutter blade includes:
an attachment portion attached to the rotary shaft; and
a first arm portion and a second arm portion each extending from the attachment portion in a radially outward direction of the rotary shaft;
the first arm portion includes a first blade portion configured to cut the grass;
the second arm portion includes a second blade portion configured to cut the grass;
in a horizontal placement state in which the cutter blade is placed in a manner so that a rotation center line of the cutter blade extends along a vertical direction, a position of a first portion of the first blade portion in the vertical direction and a position of a second portion of the second blade portion in the vertical direction are different from each other; and
a distance from the rotation center line to the first portion and a distance from the rotation center line to the second portion are equal to each other.

4. The lawn mower according to claim 1, further comprising:
a housing configured to house the cutter blade therein, wherein:
the housing includes:
a front wall located forward of the rotary shaft in the traveling direction; and
a rear wall located rearward of the rotary shaft in the traveling direction;
and
in the state where the lawn mower is disposed horizontally, a position of a lower end of the front wall in a vertical direction is higher than a position of a lower end of the rear wall in the vertical direction.

5. The lawn mower according to claim 3, wherein
the first arm portion and the second arm portion extend in directions opposite to each other with the attachment portion being centered.

6. The lawn mower according to claim 1, further comprising:
an attachment portion attached to the rotary shaft; and
a first arm portion and a second arm portion each extending from the attachment portion in a radially outward direction,
wherein only the first arm portion among the first arm portion and the second arm portion includes a wing portion that is inclined upward, with respect to a reverse rotation direction opposite to a blade rotation direction which is a rotation direction of the cutter blade.
